(19) United States
(12) Patent Application Publication
(10) Pub. No.: US 2011/0123948 A1
(43) Pub. Date: May 26, 2011

(54) Two-part rotational dental implant abutment for use with existing implant bases

(76) Inventor: Uwe Hinrichsen, Boca Raton, FL (US)

(21) Appl. No.: 12/453,574

(22) Filed: May 15, 2009

Related U.S. Application Data
(60) Provisional application No. 61/128,008, filed on May 15, 2008.

(51) Int. Cl. A61C 8/00

(52) U.S. Cl. 433/173

(57) ABSTRACT

A two-part abutment for attachment between a dental implant and a restorative fixture may be oriented at an angle of between 0° and 35°, and manipulated between four to twelve directions or positions in addition to the directions in which the implant itself may be manipulated so that the restorative fixture may be oriented in the proper position within the mouth of a patient.

### FIELD OF THE INVENTION

This invention relates to dental implants, and, more particularly, to a universal, multi-directional abutment that may be attached to an osseointegrated dental implant and manipulated in a number of directions to accommodate misalignment of the implant so that a restorative fixture may be located in the proper position in the mouth.

### BACKGROUND OF THE INVENTION

When dental implants are fixed in the mouth, they are not always in an optimum position to receive a restorative fixture. A common problem among implant manufacturers is the creation of a standardized, off-the-shelf component or abutment that may be manipulated in a number of directions to receive the restorative fixture. Historically, abutments have been provided at fixed angles of 15° to 25°. Alternatively, higher cost and labor intensive custom abutments have been created.

### SUMMARY OF THE INVENTION

This invention is directed to a two-part abutment for attachment between a dental implant and a restorative fixture which may be oriented at an angle of between 0° and 35°, and manipulated between 4 to 12 directions or positions in addition to the 4 to 8 positions in which the implant itself may be manipulated. The abutment features a double internal hexagonal/octagonal design, and may be formed of plastic, titanium or zirconium.

### BRIEF DESCRIPTION OF THE DRAWINGS

The structure, operation and advantages of the presently preferred embodiment of this invention will become further apparent upon consideration of the following description, taken in conjunction with the accompanying drawings, wherein:

FIG. 1 is a perspective view of an implant with both parts assembled depicting an angled abutment with a tri-lobe design;

FIG. 2 is a front view of the implant shown in FIG. 1;

FIG. 3 is a plan view of the implant of FIG. 1;

FIG. 4 is a side view of the implant of FIG. 1;

FIG. 5 is a perspective view of the abutment of this invention, including a component “a” which is inserted into the dental implant fixture in the mouth and a component “b” connected to component “a” via the internal structure of “a” which mates with the external structure of “b” thus allowing for 4 to 12 positions of the abutment.

FIG. 6 is an exploded, perspective view of a component “a” receiving a component “b”;

FIG. 7 is a side view of FIG. 6;

FIG. 8 is a partial, enlarged perspective view depicting the torx directional structure of the mating components “a” and “b”;

FIG. 9 depicts a series of side, perspective view of the components “a” and “b” illustrating different cuff heights;

FIG. 10 is a series of side perspective view of the components “a” and “b” depicting different angulations of the component “b;” and

FIG. 11 illustrates an exploded, perspective view of two forms of the abutment of this invention, including an implant fixture “d” which may be screwed into the bone of the jaw in position to receive a component “a,” which, in turn, receives a component “b”.

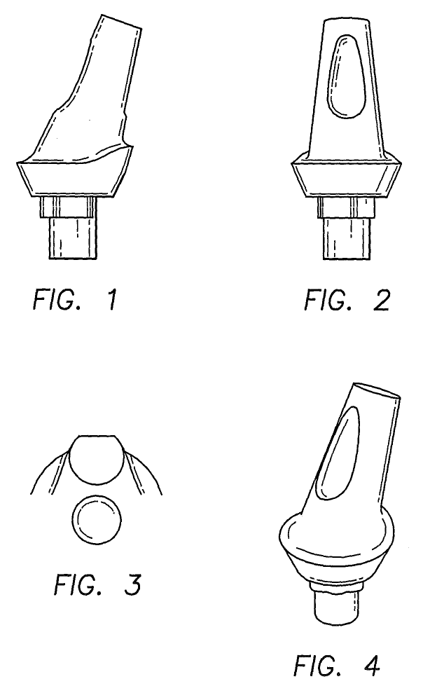

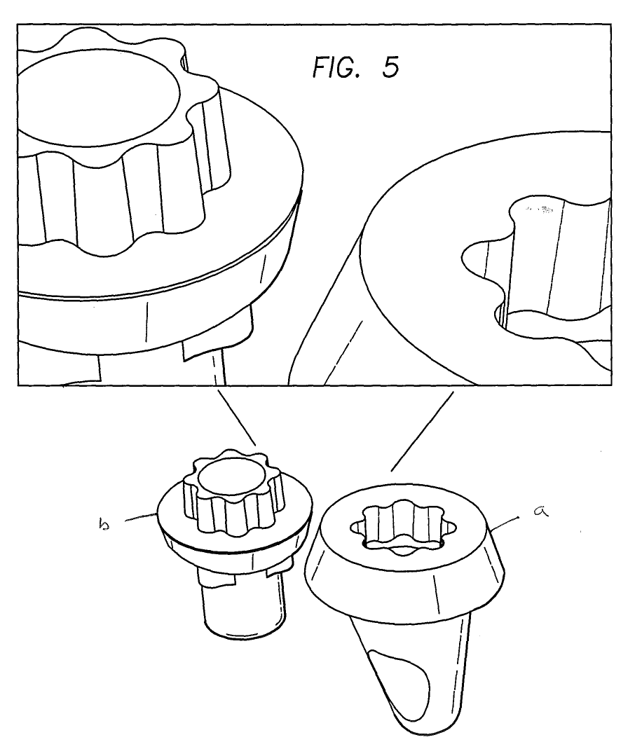

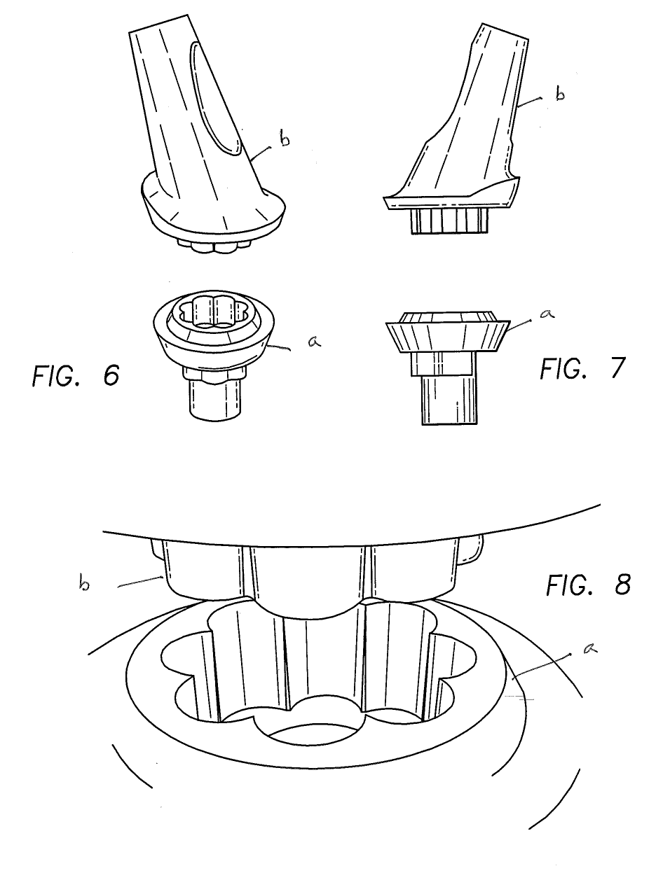

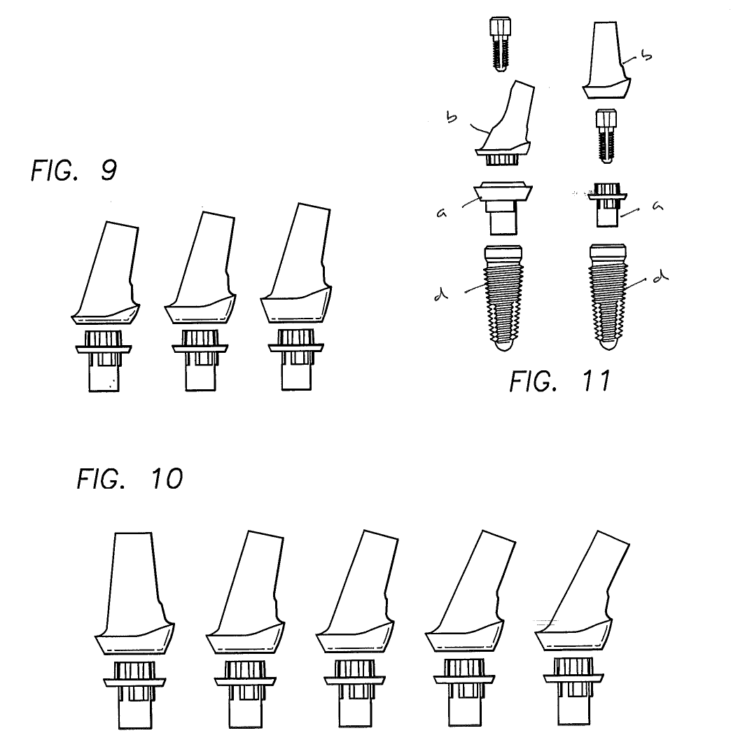

### DETAILED DESCRIPTION OF THE INVENTION

Details of components “a” and “b” of the abutment of this invention are depicted in the Figs. With reference to FIG. 11, the component “d” is threaded into the jaw bone of the patient. Component “d” is hollow and receives component “a” of the abutment. In one embodiment, components “a” and “b” forming the abutment may be fabricated of a plastic material that may be cast, and such components may be cast as one component. In another embodiment, component “a” is connected by a screw to component “d” and then component “b” is attached to component “a” using a composite cement. Component “b” may be formed of metal, Zirconia or polyether ethyleketone. In a still further embodiment, components “a” and “b” may be connected together by a screw, with the screw seat being formed in component “b.”

Through using the two part as opposed to one part abutment construction, the restorative dentist is given a number of more directional possibilities as well as by using a castable plastic, the abutment can be made to be a more affordable option as well as simplifying the directional dilemmas involved when constructing implant prostheses. This abutment construction lends itself to a number of different material combinations, as follows:

(1) Zirconium to titanium, i.e., component “a” is formed of titanium, with the screw seat being formed in component “a”, and component “b” is formed of Zirconium;

(2) Cast metal to titanium, i.e. component “a” is formed of titanium, and a dental alloy is used to form component “b” which is cast from a plastic and is formed with a screw seat; and

(3) Full cast component a and b out of dental alloy, i.e. components “a” and “b” are formed of a castable plastic and fitted together after an optimal direction has been found, and then cast from a dental alloy in one piece, with the screw being formed in component “b”; and

(4) Titanium to PEEK plastic (polyether ethyleketone), with a zirconium base connected to a PEEK abutment, and a screw seat formed in component “b”.

If a primary dental implant consists of an eight (8) position octagon, the two-part abutment of this invention increases the number of positions at which the restorative fixture may be manipulated to a total of sixty-four (64), e.g. eight (8) positions of the primary dental implant to which component “a” is connected times eight (8) positions of adjustment between component “a” and component “b.”

What is claimed is:

1. An abutment for use with a dental implant including a base insertable within the bone of the jaw and a restorative fixture, comprising:
a first component having a first end coupled to the base of the dental implant and a second end formed with first connecting structure;
a second component having a third end formed with second connecting structure and a fourth end for coupling to the restorative fixture, said first and second connecting structure being mateable with one another in such a way as to vary the orientation of said second component and the restorative fixture coupled thereto relative to the base of the dental implant.
